(19) United States
(12) Patent Application Publication
(10) Pub. No.: US 2026/0233186 A1
(43) Pub. Date: Aug. 13, 2026

(54) APPARATUS AND METHOD FOR PREPARING A DEFINED MONOMER SEQUENCE POLYMER

(71) Applicant: EXACTMER LIMITED, Harrogate (GB)

(72) Inventors: Andrew Livingston, Harrogate (GB); Jet Yeo, Harrogate (GB); Catalina Parga, Harrogate (GB)

(21) Appl. No.: 19/469,544

(22) PCT Filed: Mar. 27, 2024
(86) PCT No.: PCT/GB2024/050845

§ 371 Date: Sep. 26, 2025

(30) Foreign Application Priority Data
Mar. 28, 2023 (GB) 2304536.2
Mar. 28, 2023 (GB) 2304537.0

(51) Int. Cl. B01J 19/00

(52) U.S. Cl. CPC B01J 19/0046; B01J 2219/00495; B01J 2219/00599; B01J 2219/00722; B01J 2219/00725; B01J 2219/00729

(57) ABSTRACT

An apparatus for preparing a defined monomer sequence polymer, comprising a reactor vessel for synthesis of the defined monomer sequence polymer in liquid phase therein, the reactor vessel having one or more first inlets each for receiving one or more solvents and/or one or more reagents, and a first membrane assembly in fluid communication with an outlet of the reactor vessel, the first membrane assembly being configured to separate synthesised defined monomer sequence polymer from by-products of the synthesis and/or excess solvents and/or or excess reagents. A first outlet of the first membrane assembly is in fluid communication with a second inlet of the reactor vessel so that separated defined monomer sequence polymer may be circulated back to the reactor vessel through the second inlet. A second outlet of the first membrane assembly is in fluid communication with a third inlet of the reactor vessel so that separated solvent may be circulated back to the reactor vessel through the third inlet.

This invention relates to an apparatus and method for preparing a defined monomer sequence polymer. In particular, but not exclusively, the defined monomer sequence polymer may be an oligonucleotide.

### BACKGROUND

Oligonucleotides (oligos) have recently been validated as a new pharmaceutical modality for treating a wide range of serious or life-threatening indications. Oligos are defined monomer sequence polymers formed from a backbone of ribose phosphate monomers, with each monomer having a variable nucleobase side chain; the building block unit of ribose phosphate bound to a nucleobase constitutes a nucleotide (Nt). The precise sequence of nucleotides defines the oligo's biological function.

The industry standard method for preparing oligos is by solid phase oligo synthesis (SPOS). In SPOS the oligos are synthesised tethered to an insoluble solid support in the form of glass or polymer resin beads. Nucleotide building blocks with a reactive phosphate moiety are flowed over the solid support. Exposed hydroxy chain termini couple to the building block extending the growing oligo by one monomer unit. Uncontrolled chain extension is prevented by a temporary protecting group, most commonly 4,4′-dimethoxytriphenylmethyl (DMT, DMTr, or Dmtr). After oligo chain extension is complete the Dmtr is removed by washing the support with acid to expose a new oligo hydroxy chain terminus so that the cycle can be repeated with a new nucleotide building block. In this way any desired oligo sequence is built up.

Prior oligonucleotide synthesis has been dominated by solid phase method. The automation of solid phase synthesis enabled by state-of-the-art machines has provided many advantages. Examples of solid phase automated synthesis systems are presented in E.U. Pat. No. 1,714,695 to Bellafiore et al. U.S. Pat. No. 5,641,459 to Holmberg and U.S. Pat. No. 5,807,525 to Allen et al. The solid phase automated synthesis systems are claimed to be capable of carrying out precisely monitored, controlled, and reproducible oligonucleotide synthesis continuously. Automating the system is beneficial to the synthesis, primarily due to the reduction in costs attributed to a less labour-intensive operation, and minimized synthesis errors. Automated synthesis reduces the labour hours required, since the synthesis can be performed by repeated cycles with automated reagent additions.

Automated synthesis reduces costs associated with reagent and building-block materials by utilizing them more efficiently and results in higher yields of the desired product at lower cost. Operational costs are also reduced, including labour and facility costs. In addition, validation and quality control costs to confirm synthetic product makeup, and disposal costs of non-compliant product are reduced. The benefit of the improved process reproducibility is seen both from a regulatory (FDA) perspective where cGMP guidelines mandate a state of control be maintained throughout manufacturing processes, as well as from a manufacturing science viewpoint which predicts the lowest cost of manufacture and highest quality products results from processes which exhibit the least run to run variability. A further benefit of such reproducible processes is that multiple smaller scale runs can be made to generate material on an “as needed” basis, rather than making large scale single batches at which are at high risk idue to potential coupling failure and the resulting stockpiling of material, which decomposes over time.

The maximum scale of oligo preparation that SPOS can achieve is approximately 15 Kg of crude oligo per batch, but for a major medical indication, such as cardiovascular disease, tonnes per annum of oligo would be required, and this makes producing batches of 100 kg or more desirable

Liquid phase reactions and liquid phase material handling are established technologies that can be performed at the multi-tonne scale. Therefore, liquid phase synthesis is a strong candidate for manufacture of defined oligonucleotides at scale.

One approach to liquid phase synthesis oligonucleotides is liquid phase oligonucleotide synthesis (LPOS). In LPOS reactions are carried out in a liquid phase, adding monomers or multi-monomer oligomers (fragments) to a growing oligo in solution in a step-wise fashion, with a suitable separation technology to separate unreacted monomers or fragments from the growing oligo.

One LPOS strategy (Bonora, HELP (High Efficiency Liquid Phase) new oligonucleotide synthesis on soluble polymeric support, Nucleic Acids Research, 1990, Vol. 18, 3155; Large scale, liquid phase synthesis of oligonucleotides by the phosphoramidite approach, Nucleic Acids Research, 1993, Vol. 21, 1213-1217) has proposed using linear PEG to maintain solubility of the growing oligo in acetonitrile solution. More recently this observation was extended to DNA 20-mers grown on a PEG-star support (Walther, Scalable One-Pot-Liquid-Phase Oligonucleotide Synthesis for Model Network Hydrogels, J. Am. Chem. Soc. 2020, 142, 16610-16621) although this latter was not an LPOS method as the oligo was not designed to be detached from the support.

A further LPOS strategy is to form multi-monomer “fragments” between 2-6 nucleotides long using solution phase coupling and detritylation reactions. Chosen fragments are then activated at the 3′ position and reacted with the 5′ OH of other fragments in solution to form a final oligonucleotide with 15 or more nucleotide bases (Shi et al., “Development of Kilogram-Scale Convergent Liquid-Phase Convergent Synthesis of Oligonucleotides”, J. Org. Chem., 2022, 87, 2087-2110). During this process it was found necessary to lower the temperature to 0 degrees Celsius to maximise the oligo purity.

In the above LPOS strategies and others (PCT/US2020/032070, PCT/EP2022/059528, WO2012/157723, WO2020/017085 the growing oligo was separated from reaction debris that might interfere in subsequent cycles of chain extension by precipitation. Precipitation is a challenging procedure to make routine and practical, necessitating that filter cakes do not block the filter bed and can be efficiently washed with solvent. Because LPOS is an iterative process, and pharmaceutical products often require that oligos extend to 20-mers and beyond, it is critical that the precipitation process is highly efficient and reproducible. Bonora's HELP process necessitates one precipitation for each step of the chain extension cycle, including capping (the blocking of unreacted 5′-hydroxyls by acetylation), meaning that 87 diethyl ether precipitations were required to achieve a 20-mer. Walther et al. were able to compress their process to just one precipitation per cycle on a 4-arm PEG-star, but at the cost of an average recovery of oligo-star of only 94% per cycle, up to 11-mer. For oligos longer than 11-mer each stage required double precipitation, and the use of a DMSO/acetonitrile mixture for solubility. In these LPOS processes the equipment for oligo synthesis comprises a reaction vessel and a suitable filter for recovering and washing the solid precipitate. These processes are not strictly liquid phase because the growing oligo is cycled through a solid phase during precipitation.

Liquid-liquid extraction is a further approach to separation in LPOS and requires that the growing oligo be separated from reaction debris by using at least two immiscible phases with preferential partitioning of the oligo into one phase with reaction debris partitioning to a second phase. Lipophilic protecting groups on the T nucleobase including Benzoyl (Bz) and Pivaloyloxymethyl (Pom) have been used in synthesizing a heptameric DNA fragment so that the growing oligo remained soluble in the apolar organic phase (van der Marel et al., “Simple and Efficient Solution-Phase Synthesis of Oligonucleotides Using Extractive Work-Up”, Org. Process Res. Dev., 2006, 10, 1238-1245).

Yet another approach to sequential synthesis of oligos uses enzymatic synthesis with suitable monomers including nucleoside 5′-triphosphates combined with 3′-O-protecting groups Such enzymatic processes may be performed in aqueous solvent. (8. Biochemistry. 2018 Mar. 27; 57(12): 1821-1832. doi:10.1021/acs. biochem.7b00937).

An alternative to strategies based on precipitation or liquid-liquid extraction is to use a membrane filtration separation: After coupling of a monomer onto a defined monomer sequence polymer the membrane is used to separate unreacted monomers and reaction debris from the growing polymer. The use of membrane separation for iterative synthesis of defined monomer sequence polymers including peptides, oligonucleotides, and polyethylene glycols has been described in the prior art (U.S. Pat. Nos. 8,664,357, 9,127,123, 10,239,996, EP3347402, P. R. J. Gaffney, J. F. Kim, I. B. Valtcheva, G. D. Williams, M. S. Anson, A. M. Buswell, A. G. Livingston, Liquid-Phase Synthesis of 2′-Methyl-RNA on a Homostar Support through Organic-Solvent Nanofiltration, Chem. Eur. J., 2015, 21, 9535-9543, J. F. Kim, P. R. J. Gaffney, I. B. Valtcheva, G. Williams, A. M. Buswell, M. S. Anson, A. G. Livingston, Organic Solvent Nanofiltration (OSN): A New Technology Platform for Liquid-Phase Oligonucleotide Synthesis (LPOS), Org. Process Res. Dev. 2016, 20, 1439-1452).

It is an object of certain embodiments of the present invention to overcome one or more disadvantages associated with the prior art.

### BRIEF SUMMARY OF THE DISCLOSURE

In accordance with an aspect of the present invention there is provided an apparatus for preparing a defined monomer sequence polymer, comprising:
a reactor vessel for synthesis of the defined monomer sequence polymer in liquid phase therein, the reactor vessel having one or more first inlets each for receiving one or more solvents and/or one or more reagents; and
a first membrane assembly in fluid communication with an outlet of the reactor vessel, the first membrane assembly being configured to separate synthesised defined monomer sequence polymer from by-products of the synthesis and/or excess solvents and/or or excess reagents;
wherein a first outlet of the first membrane assembly is in fluid communication with a second inlet of the reactor vessel so that separated defined monomer sequence polymer may be circulated back to the reactor vessel through the second inlet; and
wherein a second outlet of the first membrane assembly is in fluid communication with a third inlet of the reactor vessel so that separated solvent may be circulated back to the reactor vessel through the third inlet.

The apparatus may comprise a primary loop, the primary loop being a closed loop of first conduits that define a first fluid flow path, wherein the first fluid flow path includes the reactor vessel and the first membrane assembly.

The apparatus may comprise a second membrane assembly fluidly connected between the second outlet of the first membrane assembly and the third inlet of the reactor vessel, the second membrane assembly having a first outlet and a second outlet and is configured to separate excess solvents from other products such that the separated excess solvents pass through the first outlet of the second membrane assembly and the other products pass through the second outlet of the second membrane assembly.

The apparatus may comprise an intermediate vessel having a first inlet in fluid communication with the second outlet of the first membrane assembly, a first outlet in fluid communication with the second membrane assembly, and a second inlet in fluid communication with the second outlet of the second membrane assembly.

The apparatus may comprise a secondary loop, the secondary loop being a closed loop of second conduits defining a second fluid flow path, wherein the second fluid flow path includes the intermediate vessel and the second membrane assembly.

In certain embodiments, the apparatus may comprise means for receiving one or more signals each indicative of a volume of liquid in the reactor vessel and/or the first membrane assembly and/or in any intermediate conduits fluidly connecting the reactor vessel and the first membrane assembly; and
means for controlling the addition of one or more solvents through the one or more first inlets and/or third inlet in dependence on the one or more signals.

In certain embodiments, the means for receiving one or more signals each indicative of a volume of liquid in the reactor vessel and/or the first membrane assembly and/or in any intermediate conduits fluidly connecting the reactor vessel and the first membrane assembly may comprise one or more level sensors.

In certain embodiments, the means for controlling the addition of one or more solvents through the one or more first inlets in dependence on the one or more signals may comprise one or more controllable valves. Additionally or alternatively, the means for controlling the addition of one or more solvents through the one or more first inlets in dependence on the one or more signals may comprise a programmable logic controller The apparatus may comprise a heat exchanger arranged to heat fluid passing through the reactor vessel and/or the first membrane assembly. The heat exchanger may comprise an in-line heat exchanger positioned between and fluidly connected to the reactor vessel and the first membrane assembly. Alternatively, the heat exchanger may comprise a thermal jacket enclosing at least part of, and arranged to heat or cool the contents of, the reactor vessel and/or first membrane assembly.

The thermal jacket may have a coolant input and a coolant output to permit the passage of coolant through the thermal jacket.

In certain embodiments that include the thermal jacket, the apparatus may not comprise any in-line heat exchangers.

The apparatus may comprise means for maintaining the primary loop at a pressure greater than atmospheric pressure.

Additionally or alternatively, the apparatus may comprise means for maintaining the secondary loop at a pressure greater than atmospheric pressure.

The first membrane assembly may comprise one or more first membrane housings each housing a first membrane. In certain embodiments, the first membrane may comprise one of a spiral wound membrane, a circular membrane, a tubular membrane, or a planar membrane. In certain embodiments, the first membrane may comprise a ceramic membrane or a polymeric membrane.

Additionally or alternatively, the second membrane assembly may comprise one or more second membrane housings each housing a second membrane. The second membrane may comprise one of a spiral wound membrane, a circular membrane, a tubular membrane, or a planar membrane. The first membrane may comprise a ceramic membrane or a polymeric membrane.

The apparatus may comprise one or more solvent sources each fluidly connected to at least one of the one or more first inlets of the reactor vessel.

The apparatus may comprise one or more reagent sources each fluidly connected to at least one of the one or more first inlets of the reactor vessel.

In accordance with another aspect of the present invention, there is provided a method of preparing a defined monomer sequence polymer using the apparatus described above, the method comprising:
providing one or more solvents and one or more reagents to the reactor vessel through the one or more inlets of the reactor vessel;
synthesising the defined monomer sequence polymer in liquid phase in the reactor vessel using the one or more solvents and one or more reagents;
using the first membrane assembly to separate synthesised defined monomer sequence polymer from by-products of the synthesis and/or excess solvents and/or or excess reagents;
circulating separated defined monomer sequence polymer back to the reactor vessel through the second inlet of the reactor vessel; and
circulating separated solvent back to the reactor vessel through the third inlet of the reactor vessel.

In certain embodiments, the defined monomer sequence polymer may be an oligonucleotide.

In accordance with another aspect of the present invention, there is provided an apparatus for preparing a defined monomer sequence polymer, comprising:
a reactor vessel for synthesis of the defined monomer sequence polymer in liquid phase therein, the reactor vessel having one or more first inlets each for receiving one or more solvents and/or one or more reagents;
a first membrane assembly in fluid communication with an outlet of the reactor vessel, the first membrane assembly being configured to separate synthesised defined monomer sequence polymer from by-products of the synthesis and/or excess solvents and/or or excess reagents, wherein a first outlet of the first membrane assembly is in fluid communication with a second inlet of the reactor vessel so that separated defined monomer sequence polymer may be circulated back to the reactor vessel through the second inlet; and
a thermal jacket enclosing at least part of, and arranged to heat or cool the contents of, the reactor vessel and/or first membrane assembly.

The thermal jacket may have a coolant input and a coolant output to permit the passage of coolant through the thermal jacket.

In certain embodiments that include the thermal jacket, the apparatus may not comprise any in-line heat exchangers.

In certain embodiments, a second outlet of the first membrane assembly may be in fluid communication with a third inlet of the reactor vessel so that separated solvent may be circulated back to the reactor vessel through the third inlet.

The apparatus may comprise a primary loop, the primary loop being a closed loop of first conduits that define a first fluid flow path, wherein the first fluid flow path includes the reactor vessel and the first membrane assembly.

The apparatus may comprise a second membrane assembly fluidly connected between the second outlet of the first membrane assembly and the third inlet of the reactor vessel, the second membrane assembly having a first outlet and a second outlet and is configured to separate excess solvents from other products such that the separated excess solvents pass through the first outlet of the second membrane assembly and the other products pass through the second outlet of the second membrane assembly.

The apparatus may comprise an intermediate vessel having a first inlet in fluid communication with the second outlet of the first membrane assembly, a first outlet in fluid communication with the second membrane assembly, and a second inlet in fluid communication with the second outlet of the second membrane assembly.

The apparatus may comprise a secondary loop, the secondary loop being a closed loop of second conduits defining a second fluid flow path, wherein the second fluid flow path includes the intermediate vessel and the second membrane assembly.

In certain embodiments, the apparatus may comprise means for receiving one or more signals each indicative of a volume of liquid in the reactor vessel and/or the first membrane assembly and/or in any intermediate conduits fluidly connecting the reactor vessel and the first membrane assembly; and means for controlling the addition of one or more solvents through the one or more first inlets and/or third inlet in dependence on the one or more signals.

In certain embodiments, the means for receiving one or more signals each indicative of a volume of liquid in the reactor vessel and/or the first membrane assembly and/or in any intermediate conduits fluidly connecting the reactor vessel and the first membrane assembly may comprise one or more level sensors.

In certain embodiments, the means for controlling the addition of one or more solvents through the one or more first inlets in dependence on the one or more signals may comprise one or more controllable valves. Additionally or alternatively, the means for controlling the addition of one or more solvents through the one or more first inlets in dependence on the one or more signals may comprise a programmable logic controller The apparatus may comprise means for maintaining the primary loop at a pressure greater than atmospheric pressure.

Additionally or alternatively, the apparatus may comprise means for maintaining the secondary loop at a pressure greater than atmospheric pressure.

The first membrane assembly may comprise one or more first membrane housings each housing a first membrane. In certain embodiments, the first membrane may comprise one of a spiral wound membrane, a circular membrane, a tubular membrane, or a planar membrane. In certain embodiments, the first membrane may comprise a ceramic membrane or a polymeric membrane.

Additionally or alternatively, the second membrane assembly may comprise one or more second membrane housings each housing a second membrane. The second membrane may comprise one of a spiral wound membrane, a circular membrane, a tubular membrane or a planar membrane. The first membrane may comprise a ceramic membrane or a polymeric membrane.

The apparatus may comprise one or more solvent sources each fluidly connected to at least one of the one or more first inlets of the reactor vessel.

The apparatus may comprise one or more reagent sources each fluidly connected to at least one of the one or more first inlets of the reactor vessel.

In accordance with another aspect of the present invention, there is provided an apparatus for preparing a defined monomer sequence polymer, comprising:
a reactor vessel for synthesis of the defined monomer sequence polymer in liquid phase therein, the reactor vessel having one or more first inlets each for receiving one or more solvents and/or one or more reagents;
a first membrane assembly in fluid communication with an outlet of the reactor vessel, the first membrane assembly being configured to separate synthesised defined monomer sequence polymer from by-products of the synthesis and/or excess solvents and/or or excess reagents, wherein a first outlet of the first membrane assembly is in fluid communication with a second inlet of the reactor vessel so that separated defined monomer sequence polymer may be circulated back to the reactor vessel through the second inlet;
means for receiving one or more signals each indicative of a volume of liquid in the reactor vessel and/or the first membrane assembly and/or in any intermediate conduits fluidly connecting the reactor vessel and the first membrane assembly; and
means for controlling the addition of one or more solvents through the one or more first inlets in dependence on the one or more signals.

In certain embodiments, the means for receiving one or more signals each indicative of a volume of liquid in the reactor vessel and/or the first membrane assembly and/or in any intermediate conduits fluidly connecting the reactor vessel and the first membrane assembly may comprise one or more level sensors.

In certain embodiments, the means for controlling the addition of one or more solvents through the one or more first inlets in dependence on the one or more signals may comprise one or more controllable valves. Additionally or alternatively, the means for controlling the addition of one or more solvents through the one or more first inlets in dependence on the one or more signals may comprise a programmable logic controller In certain embodiments, a second outlet of the first membrane assembly may be in fluid communication with a third inlet of the reactor vessel so that separated solvent may be circulated back to the reactor vessel through the third inlet.

The apparatus may comprise a primary loop, the primary loop being a closed loop of first conduits that define a first fluid flow path, wherein the first fluid flow path includes the reactor vessel and the first membrane assembly.

The apparatus may comprise a second membrane assembly fluidly connected between the second outlet of the first membrane assembly and the third inlet of the reactor vessel, the second membrane assembly having a first outlet and a second outlet and is configured to separate excess solvents from other products such that the separated excess solvents pass through the first outlet of the second membrane assembly and the other products pass through the second outlet of the second membrane assembly.

The apparatus may comprise an intermediate vessel having a first inlet in fluid communication with the second outlet of the first membrane assembly, a first outlet in fluid communication with the second membrane assembly, and a second inlet in fluid communication with the second outlet of the second membrane assembly.

The apparatus may comprise a secondary loop, the secondary loop being a closed loop of second conduits defining a second fluid flow path, wherein the second fluid flow path includes the intermediate vessel and the second membrane assembly.

The apparatus may comprise a heat exchanger arranged to heat fluid passing through the reactor vessel and/or the first membrane assembly. The heat exchanger may comprise an in-line heat exchanger positioned between and fluidly connected to the reactor vessel and the first membrane assembly. Alternatively, the heat exchanger may comprise a thermal jacket enclosing at least part of, and arranged to heat or cool the contents of, the reactor vessel and/or first membrane assembly.

The thermal jacket may have a coolant input and a coolant output to permit the passage of coolant through the thermal jacket.

In certain embodiments that include the thermal jacket, the apparatus may not comprise any in-line heat exchangers.

The apparatus may comprise means for maintaining the primary loop at a pressure greater than atmospheric pressure.

Additionally or alternatively, the apparatus may comprise means for maintaining the secondary loop at a pressure greater than atmospheric pressure.

The first membrane assembly may comprise one or more first membrane housings each housing a first membrane. In certain embodiments, the first membrane may comprise one of a spiral wound membrane, a circular membrane, a tubular membrane, or a planar membrane. In certain embodiments, the first membrane may comprise a ceramic membrane or a polymeric membrane.

Additionally or alternatively, the second membrane assembly may comprise one or more second membrane housings each housing a second membrane. The second membrane may comprise one of a spiral wound membrane, a circular membrane, a tubular membrane or a planar membrane. The first membrane may comprise a ceramic membrane or a polymeric membrane.

The apparatus may comprise one or more solvent sources each fluidly connected to at least one of the one or more first inlets of the reactor vessel.

The apparatus may comprise one or more reagent sources each fluidly connected to at least one of the one or more first inlets of the reactor vessel.

In accordance with another aspect of the present invention, there is provided a method of preparing a defined monomer sequence polymer using the apparatus described above, the method comprising:
providing one or more solvents and one or more reagents to the reactor vessel through the one or more inlets of the reactor vessel;
synthesising the defined monomer sequence polymer in liquid phase in the reactor vessel using the one or more solvents and one or more reagents;
using the first membrane assembly to separate synthesised defined monomer sequence polymer from by-products of the synthesis and/or excess solvents and/or or excess reagents;
circulating separated defined monomer sequence polymer back to the reactor vessel through the second inlet of the reactor vessel;
receiving one or more signals each indicative of a volume of liquid in the reactor vessel and/or the first membrane assembly and/or in any intermediate conduits fluidly connecting the reactor vessel and the first membrane assembly; and
controlling the addition of one or more solvents through the one or more first inlets in dependence on the one or more signals.

In certain embodiments, the defined monomer sequence polymer may be an oligonucleotide.

In any aspect or embodiment, at least two of the monomeric units of the defined monomer sequence polymer may be distinct from each other.

### BRIEF DESCRIPTION OF THE DRAWINGS

Embodiments of the invention are further described hereinafter with reference to the accompanying drawings, in which:

FIG. 1 is an apparatus for preparing a defined monomer sequence polymer in accordance with an embodiment of the present invention;

FIG. 2 is an apparatus for preparing a defined monomer sequence polymer in accordance with another embodiment of the present invention;

FIG. 3 is an apparatus for preparing a defined monomer sequence polymer in accordance with another embodiment of the present invention; and

FIG. 4 is an apparatus for preparing a defined monomer sequence polymer in accordance with another embodiment of the present invention.

### DETAILED DESCRIPTION

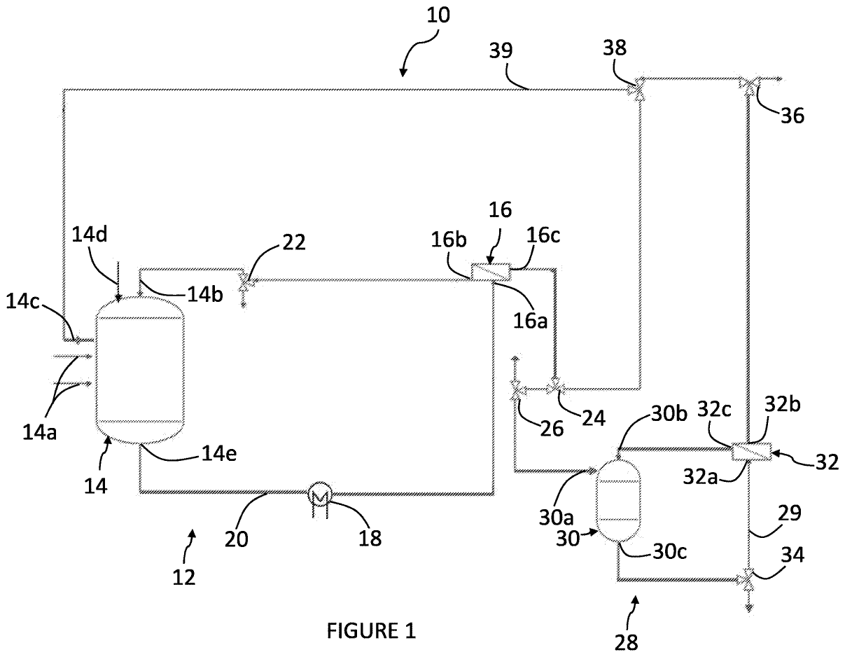

An apparatus 10 for preparing a defined monomer sequence polymer is shown schematically in FIG. 1. At least two of the monomeric units of the defined monomer sequence polymer are distinct from each other.

The apparatus 10 may be configured for continuous and automated operation. The apparatus 10 may comprise a primary loop 12 and, optionally, a secondary loop 28. The primary loop 12 is formed by a closed loop of first conduits 20 that define a first fluid flow path. Along the first fluid flow path and fluidly integrated therewith, there is provided a reactor vessel 14 and a first membrane assembly 16. As is described further below, the first membrane assembly 16 enables nanofiltration or diafiltration. In the non-limiting embodiment shown in FIG. 1, a heat exchanger 18 is also provided, the heat exchanger 18 being an in-line heat exchanger positioned between and fluidly connected to the reactor vessel 14 and the first membrane assembly 16.

The reactor vessel 14 has one or more first inlets 14a for receiving one or more solvents and/or one or more reagents, and a first outlet 14e. The one or more solvents may be organic solvents. The first outlet 14e is fluidly connected to a first inlet 16a of the first membrane assembly 16 via the heat exchanger 18. The reactor vessel 14 is configured to synthesise defined monomer sequence polymer in liquid phase using the one or more solvents and one or more reagents (which include monomers).

The reactor vessel 14, first membrane assembly 16, first conduits 20 and any other fluid-contacting parts of the apparatus 10 may be formed from any suitable material including but not limited to metals and/or polymeric materials. Suitable, but non-limiting materials include steel, stainless steel, Hastelloy, titanium, PTFE and PEEK.

In a non-limiting example according to an embodiment of the present invention, the reactor vessel 14 comprises Borosilicate glass 3.3, with polytetrafluoroethylene (PTFE) gaskets sealing the glass vessel with stainless steel plates. Such a glass-type reactor vessel 14 may aid the visualisation of the contents contained therein.

In certain embodiments, the reactor vessel 14 comprises a stir-tank reactor, or in other embodiments, other stirring means are provided for stirring the contents of the reactor vessel 14.

The defined monomer sequence polymer is prepared by the apparatus 10 by a plurality of sequential coupling, deprotection and separation steps, thereby facilitating the synthesis of a variety of peptides, oligonucleotides and peptide nucleic acids. Such steps may be in accordance with those described in EP3347402, the contents of which are incorporated herein by reference.

Upon addition of suitable solvents and reagents through the one or more first inlets 14a of the reactor vessel 14 a backbone portion of a first compound is synthesised by one or more sequential monomeric coupling reactions in a first organic solvent. At least one of the monomeric units used in the sequential monomeric coupling reactions may comprise a reactive side chain precursor group, such that the backbone portion comprises one or more reactive side chain precursor groups located at one or more predetermined positions along its length. Between each coupling reaction, a product of said one or more sequential coupling reactions may be separated from at least one second compound, which is a reaction by-product of the synthesis of the product and/or an excess of a reagent used for the synthesis of the product. Subsequently, one or more side chains may be attached to the one or more reactive side chain precursor groups located along the length of the backbone portion. During the step of separating a product of said one or more sequential coupling reactions from at least one second compound, the product of said one or more sequential coupling reactions and at least one second compound may be dissolved in a second organic solvent. As described further below, the product of said one or more sequential coupling reactions and the at least one second compound may be separated by a process of diafiltration using the first membrane assembly 16. The first membrane of the first membrane assembly is stable in the organic solvent and provides a rejection for the product which is greater than the rejection for the second compound.

In certain embodiments, the first solvent and the second solvent may be the same or different. Suitably, the solvent used for the diafiltration should maintain the polymer and/or the functionalised polymer in solution. Exemplary solvents include aromatics, alkanes, ketones, glycols, chlorinated solvents, esters, ethers, amines, nitriles, aldehydes, phenols, amides, carboxylic acids, alcohols, furans, and dipolar aprotic solvents, and mixtures thereof and with water. Specific examples of solvents include toluene, xylene, benzene, styrene, anisole, chlorobenzene, dichlorobenzene, chloroform, dichloromethane, dichloroethane, methyl acetate, ethyl acetate, butyl acetate, methyl ether ketone (MEK), methyl isobutyl ketone (MIBK), acetone, ethylene glycols, ethanol, methanol, propanol, butanol, hexane, cyclohexane, dimethoxyethane, methyl tert-butyl ether (MTBE), diethyl ether, adiponitrile, N,N-dimethylformamide, dimethylsulfoxide, N,N-dimethylacetamide, dioxane, nitromethane, nitrobenzene, pyridine, carbon disulfide, tetrahydrofuran, methyl-tetrahydrofuran, N-methyl pyrrolidone, N-ethyl pyrrolidone, acetonitrile, sulfolane and mixtures thereof and with water.

Embodiments of the present invention may produce a defined monomer sequence polymer at laboratory, pilot, and/or commercial scale. In certain embodiments, the defined monomer sequence polymer may be an oligonucleotide. Apparatuses in accordance with embodiments of the present invention may allow the continuous synthesis of oligonucleotides via cycles of oligonucleotide reactions and diafiltration in organic solvents. Similar configurations can be used for the synthesis of other active pharmaceutical ingredients such as peptides or other precise mass polymers.

Synthesised defined monomer sequence polymer, together with by-products of the synthesis, excess solvents and excess reagents, passes out of the reactor vessel 14 through the first outlet 14e and passes (via the heat exchanger 18) into the first membrane assembly 16 through its first inlet 16a. The first membrane assembly 16 separates the defined monomer sequence polymer from the by-products of the synthesis, the excess solvents and the excess reagents. A first outlet 16b of the first membrane assembly 16 is in fluid communication with a second inlet 14b of the reactor vessel 14 so that the separated defined monomer sequence polymer may be circulated back to the reactor vessel 14 through the second inlet 14b. Subsequent coupling, deprotection and separation steps may then proceed.

The first membrane assembly 16 has a second outlet 16c that is in fluid communication with a third inlet 14c of the reactor vessel 14 along a solvent return line 39. Separated solvents (at least) pass out of the second outlet 16c of the first membrane assembly 16 and are returned to the reactor vessel 14 along the solvent return line 39 and through the third inlet 14c of the reactor vessel 14.

Optionally, products (which include excess solvents and possibly other products) exiting the first membrane assembly 16 through the second outlet 16c may pass through a second membrane assembly 32 prior to returning to the reactor vessel 14 along the solvent return line 39. The second membrane assembly 32 comprises a second membrane housing and a second membrane housed in the second membrane housing, and may separate excess solvents from other products so as to purify the recovered excess solvents prior to them returning to the reactor vessel 14. For example, the second membrane may be selected to permit solvent to permeate therethrough whilst rejecting debris. The second membrane may be tighter (i.e. have a lower molecular weight cut off) than a membrane of the first membrane assembly 16.

In the non-limiting embodiment shown in FIG. 1, the apparatus 10 additionally comprises a secondary loop 28 and products discharged from the second outlet 16c of the first membrane assembly 16 (i.e. permeate of the first membrane) may pass through the secondary loop 28 prior to solvents returning to the reactor vessel 14 along the solvent return line 39. The secondary loop 28 includes the second membrane assembly 32 and an intermediate vessel 30. The intermediate vessel 30 has a first inlet 30a in fluid communication with the second outlet 16c of the first membrane assembly 16, and a first outlet 30c in fluid communication with a first inlet 32a of the second membrane assembly 32. The secondary loop 28 is formed by a closed loop of second conduits 29 that define a second fluid flow path. Along the second fluid flow path and fluidly integrated therewith, the intermediate vessel 30 and the second membrane assembly 32 are provided. The intermediate vessel 30 provides additional fluidic volume to the secondary loop 28.

The second membrane assembly 32 has a first outlet 32b that directs separated solvent to the third inlet 14c of the reactor vessel 14 along the solvent return line 39. Additionally, the second membrane assembly 32 has a second outlet 32c that directs the remaining constituents of the fluid back to the intermediate vessel 30 via a second inlet 30b of the intermediate vessel 30. Since the fluid returned to the intermediate vessel 30 may still contain some solvent, fluid may be circulated several times around the secondary loop 28 in order to separate and purify the solvent from any other products present in the fluid.

In certain embodiments, the secondary loop 28 may comprise any or all of a level transmitter for measuring a level in the intermediate vessel 30 (and optionally outputting a signal that may control other components of the apparatus 10), a heat exchanger and a flow meter.

A series of three-way valves 22, 24, 26, 34, 36, 38 are provided to control direction of fluid flow within the apparatus 10. In alternative embodiments, other valve arrangements or other means for directing the flow of fluids may be provided in place of any or all of the three-way valves 22, 24, 26, 34, 36, 38. In particular, a first three-way valve 22 is provided in the primary loop 12 between the first membrane assembly 16 and the reactor vessel 14. The first three-way valve 22 may permit fluid flow from the first membrane assembly 16 to the reactor vessel 14, or it may divert fluid flow out of the primary loop 12, e.g. for collection, sampling or discharging waste. A second three-way valve 24 is provided proximate to the second outlet 16c of the first membrane assembly 16. The second three-way valve 24 may direct fluid flow from the second outlet 16c of the first membrane assembly 16 towards the solvent return line 39 (via a sixth three-way valve, described further below) or alternatively towards a third three-way valve 26 which direct fluid flow towards the intermediate vessel 30 or alternatively out of the apparatus for collection, sampling and/or discharging waste. A fourth three-way valve 34 is provided in the secondary loop 28 between the intermediate vessel 30 and the second membrane assembly 32, wherein the fourth three-way valve 34 directs fluid flow from the intermediate vessel 30 to the second membrane assembly 32 or alternatively directs fluid flow out of the apparatus 10 for collection, sampling and/or discharging waste. A fifth three-way valve 36 is provided in fluid communication with the first outlet 32b of the second membrane assembly 32, wherein the fifth three-way valve 36 directs fluid flow from the first outlet 32b of the second membrane assembly 32 towards the sixth three-way valve 38 or alternatively directs fluid flow out of the apparatus 10 for collection, sampling and/or discharging waste. The sixth three-way valve receives fluid from either the second three-way valve 24 or the fifth three-way valve 36 and directs it towards the third inlet 14c of the reactor vessel 14 along the solvent return line 39.

Any or all of the series of three-way valves 22, 24, 26, 34, 36, 38 may be manually or automatically operable to direct or receive fluid flow along the permitted routes therewithin. Any or all of the series of three-way valves 22, 24, 26, 34, 36, 38 may be a solenoid valve. Additional or alternative valves may be employed in place of those described above, or at additional positions along flow paths within the apparatus 10.

In certain embodiments, drying means for drying the solvent may be provided in the apparatus 10. In certain embodiments, such drying means may be provided in the primary loop 12, the secondary loop 28 or along a flow path that is downstream of the second outlet 16c of the second membrane assembly 16. For example, such drying means may be provided along the solvent return line 39 so that solvent passing out of the second outlet 16c of the first membrane assembly 16 may be dried whether it has passed through the second membrane assembly 32 or not. The drying means may comprise a drying device. In certain embodiments the drying means may be or include a suitable desiccating agent. In certain embodiments, the drying means may comprise a drying column. In certain embodiments, the drying means may comprise one or more molecular sieves. In a non-limiting example, the drying means may comprise a solvent drying column containing molecular sieves. In one example, the drying means may be added to the permeate line of the second membrane assembly 32 (i.e. downstream of the first outlet 32b of the second membrane assembly 32) to absorb moisture and therefore reduce the water content of solvent passing back into the reactor vessel 14 via the solvent return line 39. One or more additional membrane assemblies may be placed around the drying column to further purify the solvent prior to entering the reactor vessel 14.

During diafiltration, the primary loop 12 is pressurised and a permeate control valve positioned proximate to the second outlet 16c of the first membrane assembly 16 may be open to route the permeate (i.e. all content that passes through the first membrane of the first membrane assembly 16) either to waste (via three-way valves 24, 26) or recycle back to the reactor vessel 14 (via three-way valves 24, 38 and solvent return line 39).

A mass flow meter positioned at the second outlet 16c of the first membrane assembly 16 may determine the mass flow rate out of the second outlet 16c and operation of the permeate control valve may be controlled in dependence on an output from the mass flow meter.

In a non-limiting example, the mass flow meter may be a Bronkhorst MI140-TGD-22-0-S-DA-000 mini-Coriolis mass flow meter. Additionally or alternatively, the permeate control valve may be a C5I model control valve. Wetted parts of the mass flow meter and/or permeate control valve may be made of 316L stainless steel and Kalrez. The Bronkhorst MI140 has mass flow rate range of 0-30 kg/h, a temperature limit of −20/70° C. and a maximum operating pressure of 200 bar. The C5I model control valve has a temperature limit of −10/70° C. and a maximum operating pressure of 100 bar. The mass flow meter and permeate control valve may be interfaced to one another by EtherCAT communication which permits multiple process values besides the permeate flowrate to be communicated, e.g. permeate pressure, permeate temperature, valve current, and more. Such values may be communicated to a programmable logic controller (PLC) for control of other components of the apparatus 10. In addition, safety features such as alarms or trips relating to temperature or pressure may be provided to safeguard the operation of the apparatus 10.

The reactor vessel 14 includes a fourth inlet 14d configured to receive a gas. The gas may be an inert gas, including but not limited to nitrogen or argon. The gas may fill a headspace within the reactor vessel 14. The gas-filled headspace may provide a barrier between liquid within the reactor vessel 14 and the one or more first inlets 14a, second inlet 14b, and/or third inlet 14c, thereby mitigating against the risk of unwanted back mixing of the liquid within the reactor vessel 14 and liquids entering the reactor vessel 14 via the one or more first inlets 14a, second inlet 14b, and/or third inlet 14c.

A gas may additionally or alternatively provided to the primary loop 12 not via the reactor vessel 14, wherein the gas may be an inert gas including but not limited to nitrogen or argon. The gas may facilitate regulation of the pressure in the primary loop 12.

The addition of gas to the primary loop 12 (both via the reactor vessel 14 and not) may limit or prevent the ingress of water from the atmosphere into the primary loop 12. The gas may be added via one or more valves which may be automatically or manually controllable.

Additionally or alternatively, a first pump may be provided to facilitate circulation of fluid around the primary loop 12. In certain embodiments, the first pump may be disposed proximate to the first outlet 14e of the reactor vessel 14. Similarly, a second pump may be provided to facilitate circulation of fluid around the secondary loop 28. In certain embodiments, the second pump may be disposed proximate to the first outlet 30c of the intermediate vessel 30. The first and second pumps may comprise any suitable pump for providing a desired flow rate and pressure in the primary loop 12 and secondary loop 28, respectively. Suitable pumps include, but are not limited to, positive displacement pumps such as diaphragm pumps, and lobe pumps and gear pumps.

Suitable pumps include, but are not limited to, the Wanner G03 series shaft-driven diaphragm pump. In such a pump, the pump head is constructed of 316L Stainless Steel, the diaphragm is constructed of PTFE, and the maximum inlet pressure is 17 bar with a maximum discharge pressure of 83 bar. Such a specification may be suitably operable within the operating ranges of the apparatus 10. The pump is used to control the feed flow rate around the main process loop. The first and/or second pump may be controllable to provide a ramping acceleration/deceleration in order to avoid sudden changes in flow.

The feed flow rate around the primary loop 12 may be measured by a flow meter (e.g. connected to the outlet of the first pump). In certain embodiments, the flow meter may also provide measurements on solution density, temperature, and other useful process variables along the primary loop 12. The first pump may control the feed flow rate along the primary loop 12 independence on signals received from a feedback sensor. Suitable flow meters include, but are not limited to, Coriolis flow meters. A suitable model of a Coriolis flow meter includes, but is not limited to, the RHM-03 made by Rheonik with a flow rate range of 0-5 kg/min.

In certain embodiments, a stainless steel tee piece may be added in the first conduits 20 connecting the first pump and the flow meter to accommodate a pressure transducer. The pressure transducer may be configured to continuously measure the output pressure in the primary loop 12 immediately downstream of the first pump (which is the highest point of liquid pressure of the apparatus 10). The signal (e.g. an analog signal) of the pressure transducer may be used to trip off the first pump when the pressure outlet of the first pump is determined to reach a predetermined setpoint.

In certain embodiments of the present invention, the first membrane assembly 16 may comprise a first membrane housing and a first membrane housed in the first membrane housing. In certain embodiments, the first membrane assembly 16 may comprise multiple first membrane housings, where each first membrane housing houses a first membrane. Such multiple first membrane housings and first membranes may be identical or different to one another. The multiple first membrane assemblies may be arranged in a multi-stage cascade configuration, and such configuration may enhance the diafiltration process.

In certain embodiments, the first membrane may be a ceramic membrane or a polymeric membrane. In certain embodiments, the first membrane may be one of a spiral wound membrane (or “spiral wound module” (SWM)), a circular membrane, a tubular membrane, or a planar (e.g. flat) membrane.

In an example in accordance with an embodiment of the present invention, the first membrane assembly 16 comprises a spiral wound module (SWM) housed inside a first membrane housing. The spiral wound module (SWM) may comprise a polymeric membrane, a permeate tube, permeate spacers and feed spacers. Polymer membrane sheets of the polymeric membrane are wound around the permeate tube. The membrane sheets may be glued (or otherwise adhered) on three sides forming ‘leaves’ and are attached to the permeate tube to create feed and permeate channels. The feed channel comprises the first inlet 16a and the first outlet 16b of the first membrane assembly 16, whilst the permeate channel comprises the second outlet 16c of the first membrane assembly 16. Therefore, the primary loop 12 passes through the feed channel, while debris and solution pass through the permeate channel of the first membrane assembly 16. The dimensions of the spiral wound module (SWM) and first membrane housing may be selected to attain different diafiltration performances.

In other embodiments, the first membrane assembly 16 may comprise tubular passages in a ceramic manifold. Alternatively, the first membrane assembly 16 may comprise a number of circular membrane sheets each housed in a filtration cell.

In embodiments including the second membrane assembly 32, the second membrane assembly 32 may comprise any of the configurations described above in relation to the first membrane assembly 16. The second membrane assembly 32 may be identical to or different from the first membrane assembly 16.

In certain embodiments, input and output pressures of the first membrane assembly 16 and/or second membrane assembly 32 may be measured to determine the transmembrane pressure of the respective membrane assembly. This may be achieved by the use of a pressure transducer at the input and output of the respective membrane assembly. The pressure transducers may continuously measure the input and output pressures of the respective membrane assembly. In certain embodiments, the pressure transducers may be accommodated in a tee piece, which may, for example, be a stainless steel tee piece. Outputs from either or both of the pressure transducers may be used to determine the operation of other components in the apparatus 10. For example, an output (e.g. an analog signal) from a pressure transducer measuring the input pressure of the respective membrane assembly may be used to control an aspect of the operation of a pump in the primary loop 12 or secondary loop 28. In a specific example, the respective pump may be caused to trip (i.e. stop operating) when the pressure transducer determines the input pressure of the respective membrane assembly exceeds a predetermined value.

In certain embodiments, a back pressure regulator may be connected to the first outlet 16b of the first membrane assembly 16, e.g. downstream of any pressure transducer measuring pressure at the first outlet 16b. The back pressure regulator may be actuated automatically (e.g. pneumatically) to provide a gas supply, when it is determined based on an output of the respective pressure transducer that a consistent gas supply is required for regulating the pressure. As noted above, the gas may be an inert gas, including but not limited to nitrogen or argon.

Suitable back pressure regulators include, but are not limited to, Emerson's Tescom™ 26-1700 Series pressure regulator coupled with ER5000 electropneumatic actuator. Gas pressure of less than 8.4 barg may be supplied to an electropneumatic actuator, which is controlled via a feedback loop to bring the primary loop 12 pressure, measured by the respective pressure transducer at the first outlet 16b of the first membrane assembly 16, to a predetermined setpoint, by sending a signal (e.g. an analog output) to the actuator. A gas supply of 8.4 barg may deliver up to a maximum of 34 barg on the primary loop 12.

In the embodiment described above with reference to FIG. 1, the heat exchanger 18 is an in-line heat exchanger positioned within the primary loop 12. Such a configuration may provide flexibility to process scaling as the heat exchanger area provided by the heat exchanger 18 may be selected (e.g. increased) to accommodate additional heating and cooling loads.

Suitable heat exchangers 18 include, but are not limited to, pipe in tube and shell in tube heat exchangers. In an example in accordance with an embodiment of the present invention, the heat exchanger 18 comprises Exergy's ¼″ tube size tube-in-tube type heat exchanger, constructed with 316L stainless steel with a heat transfer area of 0.11 m². The inner/outer tube maximum operating pressures of such a heat exchanger are 310/137 barg at 33° C. The operating temperature range is −130 to 425° C. Process solution flows through the inner tube of ¼″ outside diameter, while cooling/heating media flows through the outer tube of ½″ outside diameter.

Temperature is a critical process parameter in relation to the synthesis of the defined monomer sequence polymer, so control of temperature along the primary loop 12 is desirable. In certain embodiments, one or more thermostats may be used to heat and/or cool media flowing through the heat exchanger 18. Multiple thermostats may be used, wherein the thermostats have different temperature setpoints, thereby allowing more rapid changes of process temperature between setpoints in the primary loop 12. Any or all of the one or more thermostats may comprise a circulating thermostat.

A suitable circulating thermostat may be Lauda's RE 1050 G model with ethercat communication protocol. Such a thermostat can operate from −50 to 200° C. with a 10L bath tank at 2.6 kW of heating capacity and 0.6 kW of cooling capacity (at 0° C.). The ethercat communication protocol may provide a feedback control either based on the external temperature (e.g. as measured by a temperature transmitter), or internal temperature in the bath tank. In addition, safety features such as alarms or trips relating to temperature or pressure may be provided to safeguard the operation of the apparatus 10.

A temperature transmitter may be provided with a temperature probe of the temperature transmitter being located at an output of the heat exchanger 18 and configured to measure the temperature of solution in the primary loop 12. An output (e.g. an analog output) from the temperature transmitter may used to provide a signal to the thermostat which, in turn, may control or otherwise cause heating or cooling of media in the heat exchanger 18.

In addition to or in place of the heat exchanger 18, an in-line heat exchanger may be provided elsewhere in the apparatus 10 in certain embodiments, including but not limited to elsewhere on the primary loop 12, and/or on the secondary loop 28, and/or on the solvent return line 39.

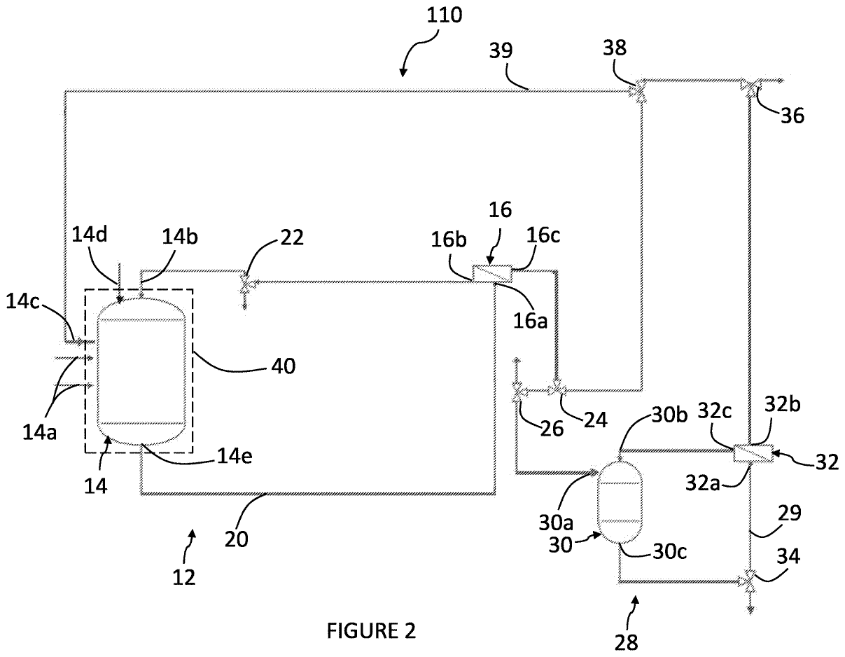

FIG. 2 shows an apparatus 110 according to an alternative embodiment of the present invention. The apparatus 110 of FIG. 2 shares many features with the apparatus 10 described above with reference to FIG. 1. Corresponding or identical features are identified with identical reference numerals. The apparatus 110 of FIG. 2 is identical to the apparatus 10 of FIG. 1 with the exception that in place of an in-line heat exchanger 18, a thermal jacket 40 is provided around the reactor vessel 14 and is configured to heat or cool the contents of the reactor vessel 14. The thermal jacket 40 may enclose some or all of the reactor vessel 14. The thermal jacket 40 may have a coolant input and a coolant output for the passage of coolant.

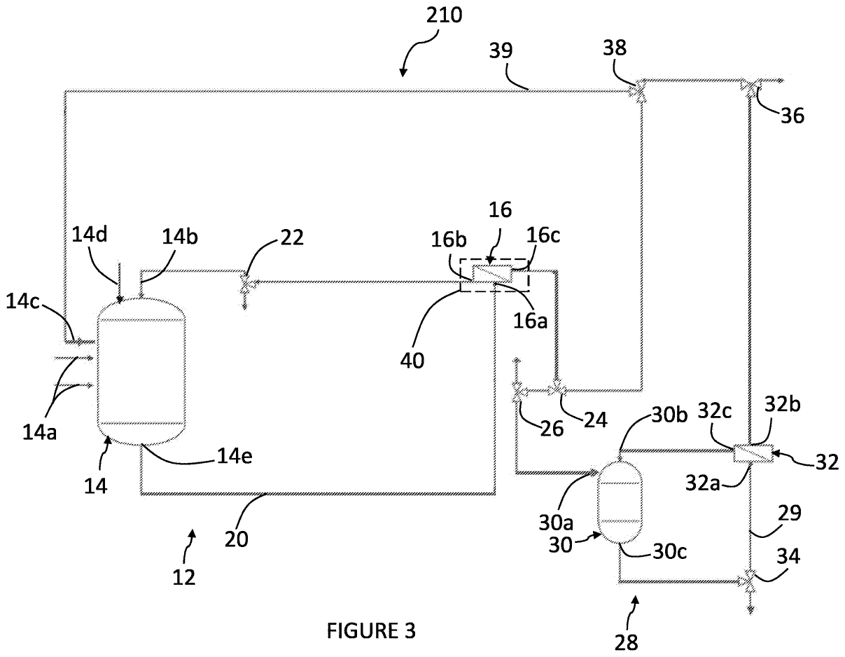

FIG. 3 shows an apparatus 210 according to an alternative embodiment of the present invention. The apparatus 210 of FIG. 3 shares many features with the apparatus 10 described above with reference to FIG. 1 and the apparatus 110 described above with reference to FIG. 2. Corresponding or identical features are identified with identical reference numerals. The apparatus 210 of FIG. 3 is identical to the apparatus 110 of FIG. 2 with the exception that instead of the thermal jacket 40 being provided around the reactor vessel 14, it is provided around the first membrane assembly 16 and is configured to heat or cool the contents of the first membrane assembly 16. The thermal jacket 40 may enclose some or all of the first membrane assembly 16. The thermal jacket 40 may have a coolant input and a coolant output for the passage of coolant.

In certain embodiments (whether or not thermal jackets are provided elsewhere), a thermal jacket may enclose some or all of the second membrane assembly 32, the thermal jacket being configured to heat or cool the contents of the second membrane assembly 32.

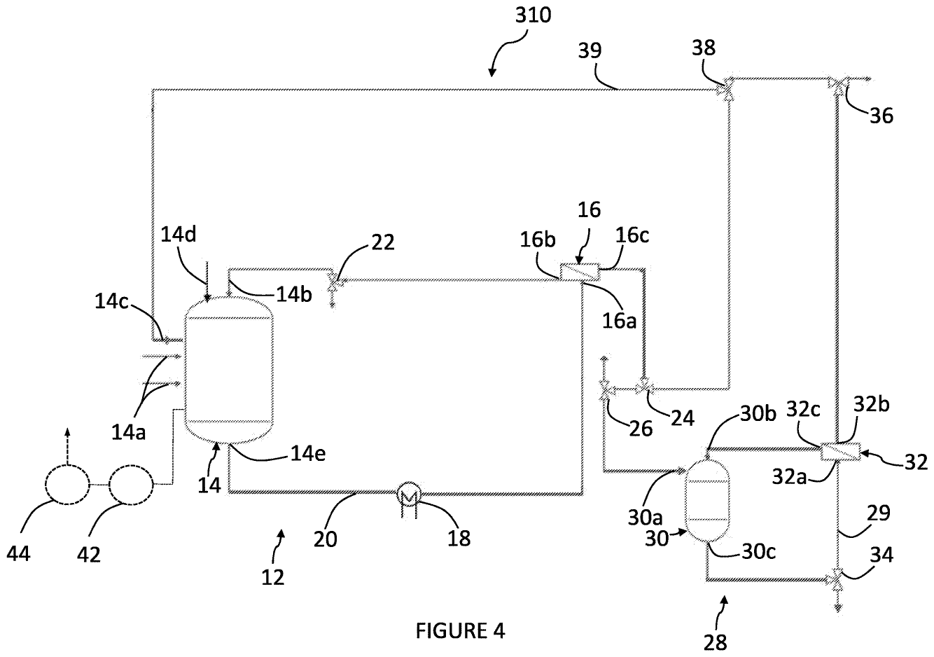

FIG. 4 shows an apparatus 310 according to an alternative embodiment of the present invention. The apparatus 310 of FIG. 4 shares many features with the apparatus 10 described above with reference to FIG. 1, the apparatus 110 described above with reference to FIG. 2, and the apparatus 210 described above with reference to FIG. 3. Corresponding or identical features are identified with identical reference numerals. The apparatus 310 of FIG. 4 is identical to the apparatus 10 of FIG. 1 with the exception that the apparatus 310 additionally includes means 42 for receiving one or more signals each indicative of a volume of liquid in the reactor vessel 14 and/or the first membrane assembly and/or in the intermediate conduits 20 fluidly connecting the reactor vessel 14 and the first membrane assembly 16, and means 44 for controlling the addition of one or more solvents through the one or more first inlets 14a and/or third inlet 14c in dependence on the one or more signals.

In embodiments where the reactor vessel 14 is provided with a gas to provide a free head space in the reactor vessel 14, in addition to mitigating against cross contaminations as described above, the free head space may enable enhanced liquid volume control in the primary loop 12. The liquid level in the reactor vessel 14 may be increased or decreased by changing a level control setpoint (e.g. associated with the means 44 for controlling the addition of one or more solvents through the one or more first inlets 14a and/or third inlet 14c), providing flexibility on the scale and concentration of synthesis within the apparatus 10. Additionally, charging the reactor vessel 14 (and, optionally, any vessels containing solvents that are in fluid communication with the one or more first inlets 14a) with a gas may reduce or prevent the ingress of moisture from the atmosphere into the apparatus by blanketing the solution (and/or dry solvent).

In certain embodiments, the means 42 for receiving one or more signals each indicative of a volume of liquid in the reactor vessel 14 and/or the first membrane assembly and/or in the intermediate conduits 20 fluidly connecting the reactor vessel 14 and the first membrane assembly 16 may comprise a level sensor, and any suitable level sensor may be used. In certain embodiments, the level sensor may be arranged to receive one or more signals each indicative of a volume of liquid in the reactor vessel 14.

Suitable level sensors include, but are not limited to, LFP Inox sensor (LFP1000-G1BMB) sensors produced by SICK. A probe of the sensor may be inserted into the reactor vessel 14 through a top plate of the reactor vessel 14. Electromagnetic waves sent by the sensor and the analog level signal produced by the sensor range from 4-20 mA depending on the time difference between sent and reflected pulse. The analog signal may be sent back to a programmable logic controller (PLC) to control the solvent filling via a feedback control. The probe of the level sensor should cover the range of the liquid level in the reaction vessel. To prevent static interference in relation to the sending and receiving of the electromagnetic waves, a returning line going into the reaction vessel 14 (e.g. via a top plate) may comprise PTFE tubing. At the end of the PTFE tubing, a tee piece made of PTFE may be used to promote mixing turbulence inside the reactor vessel 14.

Where vessels containing solvents are provided, in which such vessels are in fluid communication with the one or more inlets 14a of the reactor vessel 14, means for determining a weight or volume of such vessels may be provided, and such means may provide an output that may alert a user or another part of the apparatus to prompt the replacement of the vessel or replenishment of solvent in the vessel. Such means may include a weight transmitter and balance, for example.

In any embodiment, reagents may be dosed into the one or more first inlets 14a of the reactor vessel 14 from a reagent source. The reagent source may comprise a single vessel or a plurality of vessels, each containing a different reagent. Multiple reagent vessels may be connected to a manifold that may permit reagents from any of the reagent vessels to be added to the reactor vessel 14 through the one or more first inlets 14a. One or more flow meters and/or valves (e.g. solenoid valves) may be provided between the reagent source and the reactor vessel 14 so as to control the addition of reagents to the reactor vessel 14. Control of the addition of reagents to the reactor vessel 14 may be automated in certain embodiments.

In embodiments where the reagent source comprises multiple reagent vessels, a gas manifold may be used to keep all reagent vessels above the free gas headspace pressure of the reactor vessel 14. Selection of the valves decides which reagent is to be dosed into the reactor vessel 14 A flow meter and control valve may then control the flowrate and amount of reagent that is dosed into the reactor vessel 14. This may be followed by a washing step to clean the channel between the reagent vessel and the reactor vessel 14 prior to the next dose of reagent. The washing step may comprise dosing in pure solvent, for example acetonitrile, or by purging inert gas, for example nitrogen or argon.

The reagent source may comprise two dosing channels which combine after control valves to form a single channel that passes into one of the one or more first inlets 14a of the reactor vessel 14. This combined channel may permit the premixing of two different reagents, which is particularly advantageous for oligonucleotide synthesis. For example, phosphonamidite and DCI can be dosed in simultaneously to allow preactivation of phosphoamidite in the channel before reaching the solution inside the reactor vessel 14 to initiate coupling.

In certain embodiments of the present invention, in-situ reaction or process monitoring can be applied using in-line process analytical technology (PAT) instruments. In certain embodiments, PAT instruments may be provided on the solvent return line 39. Real-time feedback on reaction and process may allow better understanding and control of apparatuses in accordance with embodiments of the present invention. This is unlike most known automated oligonucleotide synthesis machines or systems, for example, which grow oligonucleotide on solid phase. In such systems, the in-line process analytical technology can only be applied to monitor the liquid stream going in and out of the solid phase column. In contrast, in embodiments of the present invention, a transmission probe or cell may be installed on the first conduits 20 between the first membrane assembly 16 and the reactor vessel 14 (e.g. between the back pressure regulator, if present, and the reactor vessel 14) as well as on the permeate line after the second outlet 16c of the first membrane assembly 16 for in-situ and real-time monitoring of reactions (e.g. oligonucleotide reactions) and processes.

In any embodiment, automation of any aspect of the apparatus may be achieved using a programmable logic controller (PLC).

Apparatuses in accordance with certain embodiments of the present invention may be utilized as a laboratory, pilot, and/or commercial scale synthesiser for automated liquid phase oligonucleotide synthesis. Apparatuses in accordance with certain embodiments of the present invention may perform continuous synthesis of oligonucleotide via cycles of oligonucleotide reactions and diafiltration in an enclosed process loop including a membrane filtration step. Embodiments of the present invention are also compatible with the synthesis of other precise mass polymers.

Throughout the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

The reader's attention is directed to all papers and documents which are filed concurrently with or previous to this specification in connection with this application and which are open to public inspection with this specification, and the contents of all such papers and documents are incorporated herein by reference.

1. An apparatus for preparing a defined monomer sequence polymer, comprising:
a reactor vessel for synthesis of the defined monomer sequence polymer in liquid phase therein, the reactor vessel having one or more first inlets each for receiving one or more solvents and/or one or more reagents; and
a first membrane assembly in fluid communication with an outlet of the reactor vessel, the first membrane assembly being configured to separate synthesised defined monomer sequence polymer from by-products of the synthesis and/or excess solvents and/or or excess reagents;
wherein a first outlet of the first membrane assembly is in fluid communication with a second inlet of the reactor vessel so that separated defined monomer sequence polymer may be circulated back to the reactor vessel through the second inlet; and
wherein a second outlet of the first membrane assembly is in fluid communication with a third inlet of the reactor vessel so that separated solvent may be circulated back to the reactor vessel through the third inlet;
the apparatus further comprising:
a primary loop, the primary loop being a closed loop of first conduits that define a first fluid flow path, wherein the first fluid flow path includes the reactor vessel and the first membrane assembly;
a second membrane assembly fluidly connected between the second outlet of the first membrane assembly and the third inlet of the reactor vessel, the second membrane assembly having a first outlet and a second outlet and is configured to separate excess solvents from other products such that the separated excess solvents pass through the first outlet of the second membrane assembly and the other products pass through the second outlet of the second membrane assembly;
an intermediate vessel having a first inlet in fluid communication with the second outlet of the first membrane assembly, a first outlet in fluid communication with the second membrane assembly, and a second inlet in fluid communication with the second outlet of the second membrane assembly; and
a secondary loop, the secondary loop being a closed loop of second conduits defining a second fluid flow path, wherein the second fluid flow path includes the intermediate vessel and the second membrane assembly.

2-5. (canceled)

6. The apparatus of claim 1, comprising means for receiving one or more signals each indicative of a volume of liquid in the reactor vessel and/or the first membrane assembly and/or in any intermediate conduits fluidly connecting the reactor vessel and the first membrane assembly; and
means for controlling the addition of one or more solvents through the one or more first inlets and/or third inlet in dependence on the one or more signals.

7. The apparatus of claim 1, comprising a heat exchanger arranged to heat fluid passing through the reactor vessel and/or the first membrane assembly.

8. The apparatus of claim 7, wherein the heat exchanger comprises an in-line heat exchanger positioned between and fluidly connected to the reactor vessel and the first membrane assembly.

9. The apparatus of claim 7, wherein the heat exchanger comprises a thermal jacket enclosing at least part of, and arranged to heat or cool the contents of, the reactor vessel and/or first membrane assembly.

10. The apparatus of claim 1, comprising means for maintaining the primary loop at a pressure greater than atmospheric pressure.

11. The apparatus of claim 1, comprising means for maintaining the secondary loop at a pressure greater than atmospheric pressure.

12. The apparatus of claim 1, wherein the first membrane assembly comprises one or more first membrane housings each housing a first membrane.

13. The apparatus of claim 12, wherein the first membrane comprises one of a spiral wound membrane, a circular membrane, a tubular membrane, or a planar membrane.

14. The apparatus of claim 12, wherein the first membrane comprises a ceramic membrane or a polymeric membrane.

15. The apparatus of claim 1, wherein the second membrane assembly comprises one or more second membrane housings each housing a second membrane.

16. The apparatus of claim 1, wherein the second membrane comprises one of a spiral wound membrane, a circular membrane, a tubular membrane, or a planar membrane.

17. The apparatus of claim 16, wherein the second membrane comprises a ceramic membrane or a polymeric membrane.

18. The apparatus of claim 1, comprising one or more solvent sources each fluidly connected to at least one of the one or more first inlets of the reactor vessel.

19. The apparatus of claim 1, comprising one or more reagent sources each fluidly connected to at least one of the one or more first inlets of the reactor vessel.

20. A method of preparing a defined monomer sequence polymer using the apparatus of claim 1, the method comprising:
providing one or more solvents and one or more reagents to the reactor vessel through the one or more inlets of the reactor vessel;
synthesising the defined monomer sequence polymer in liquid phase in the reactor vessel using the one or more solvents and one or more reagents;
using the first membrane assembly to separate synthesised defined monomer sequence polymer from by-products of the synthesis and/or excess solvents and/or or excess reagents;
circulating separated defined monomer sequence polymer back to the reactor vessel through the second inlet of the reactor vessel; and
circulating separated solvent back to the reactor vessel through the third inlet of the reactor vessel.
